(19) United States
(12) Patent Application Publication
(10) Pub. No.: US 2003/0181086 A1
(43) Pub. Date: Sep. 25, 2003

(54) Pressure compensated plug connector

(76) Inventors: Manfred Maletzki, Eckernforde (DE); Oliver Hirsch, Kiel (DE)

Correspondence Address: LARSON AND LARSON, 11199 69TH STREET NORTH, LARGO, FL, 33773

(21) Appl. No.: 10/276,852

(22) PCT Filed: May 18, 2001
(86) PCT No.: PCT/DE01/01921

(30) Foreign Application Priority Data
May 20, 2000 (DE) 100 25 140.4

(51) Int. Cl. H01R 4/60

(52) U.S. Cl. 439/199

(57) ABSTRACT

A pressure compensated plug connector is provided for making an electrical connection under water The connector includes a plug part provided with contact pins, a socket part having a casing for receiving a plurality of female contacts. A front plate is also included in the connector having a number of openings which correspond to the number of female contacts employed therein. The casing has at least one pressure compensating bore for compensating pressure between an inner space of the casing and the surrounding environment. A membrane separates an outer space communicating with the pressure compensating bore from an inner space filled with a non-conductive fluid surrounding the female contacts. The female contacts include a sealing sleeve adjacent to the opening, a front contact support, a sliding piston, a spring for applying force to the sliding piston, an outlet valve located between the sealing sleeve and the front contact support which connects the space occupied by the sliding piston in the unplugged state and opens to the inner space when the contact pin is inserted into the female contact, and an inlet valve located in the rear of the female contact which allows for the flow of fluid into the female contact when the contact pin is pulled out.

### PRIOR APPLICATIONS

This application bases priority on International Application No. PCT/DE01/01921, filed May 18, 2001, which in turn bases priority on German Application No. DE 100 25 140.4, filed May 20, 2000.

### BACKGROUND OF THE INVENTION

1. Field of the Invention

The invention relates to a pressure compensated plug connector having the features of the preamble of claim 1.

2. Description of the Prior Art

Electrical connectors, such as are known from U.S. Pat. No. 5,203,805, to Cairns, are particularly used in producing an electrical connection under water. A similar connector is known from EP 251655 A1.

In the case of such connectors which have to be plugged in under water, the problem arises that upon plugging in water, film adhering to the contact pin is introduced into the socket part.

The problem of the invention is to provide a connector of the aforementioned type where a reduction in the insulation resistance by introduced water or contaminants is essentially eliminated.

### SUMMARY OF THE INVENTION

According to the invention, this problem is solved by the features of claim 1. Advantageous developments of the invention are provided by the subclaims.

The basic idea of the invention is the design of the connector in such a way that on plugging in there is a flushing of the contact pin and insulation zone, and the contaminants introduced in spite of the seal are removed. The moving up of fresh oil into the insulation zone provides a reliable insulation, even after multiple plugging has taken place.

### DESCRIPTION OF THE DRAWINGS

Further advantages and features of the invention can be gathered from the following description of a preferred embodiment of the invention with reference to the attached drawings, wherein:

FIG. 1 shows a sectional representation of the pressure compensated plug connector through a socket part of said connector;

FIG. 2 shows an isolated view of the female contact; and

FIG. 3 shows the female contact of FIG. 2 wherein a contact pin is inserted into the female contact.

### DETAILED DESCRIPTION OF THE PREFERRED EMBODIMENT

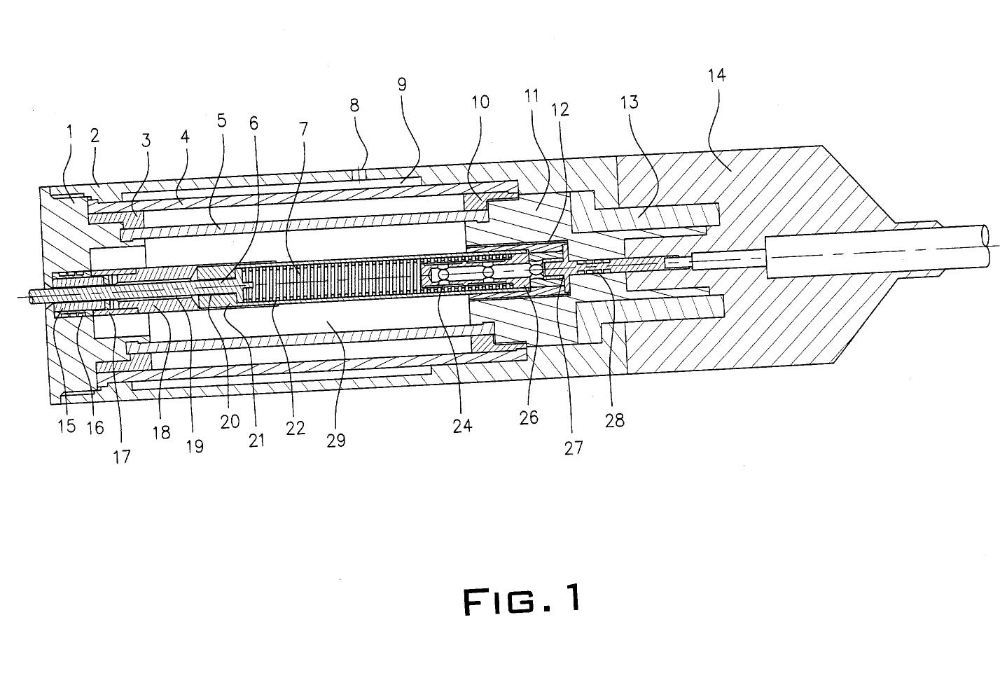

The socket part of an electrical connecter shown in FIG. 1 has a casing 2, whose end face is closed by a front plate 1. In the casing 2 is located a female contact 7 (in practice several such female contacts are provided), which is aligned with an opening in the plate 1, and which serves to introduce the contact pin of the associated plug part. An inner space 29 is formed around the female contact 7, and is filled with a non-conducting fluid, particularly an oil. Two diaphragms 5 and 4, which are retained by a front diaphragm fastening ring 3 and rear diaphragm fastening ring 10, and between which a gap is formed, are connected to the outside. Between the casing 2 and the outer diaphragm 4, is formed an outer space 9 which communicates with the surrounding water via a pressure compensating bore 8. The portion of the socket part remote from the plate 1 is formed by a rear contact receptacle 11, a sealing receptacle 13,and a seal 14.

The female contact 7, whereof only one is visible in the embodiment shown in FIG. 1, but where in practice several are provided, is constructed in the form of a cylindrical sleeve. It comprises a sealing sleeve 15, which is constructed with an O-ring contour, O-ring seals 16, an outlet valve 17, a front contact receptacle 18, a front contact support 21 on which a socket contact lamella 20 is formed, an inlet valve 24 which is located in the rear area of the female contact 7, a rear contact support 26, a solder contact 27, and a cable strand 28.

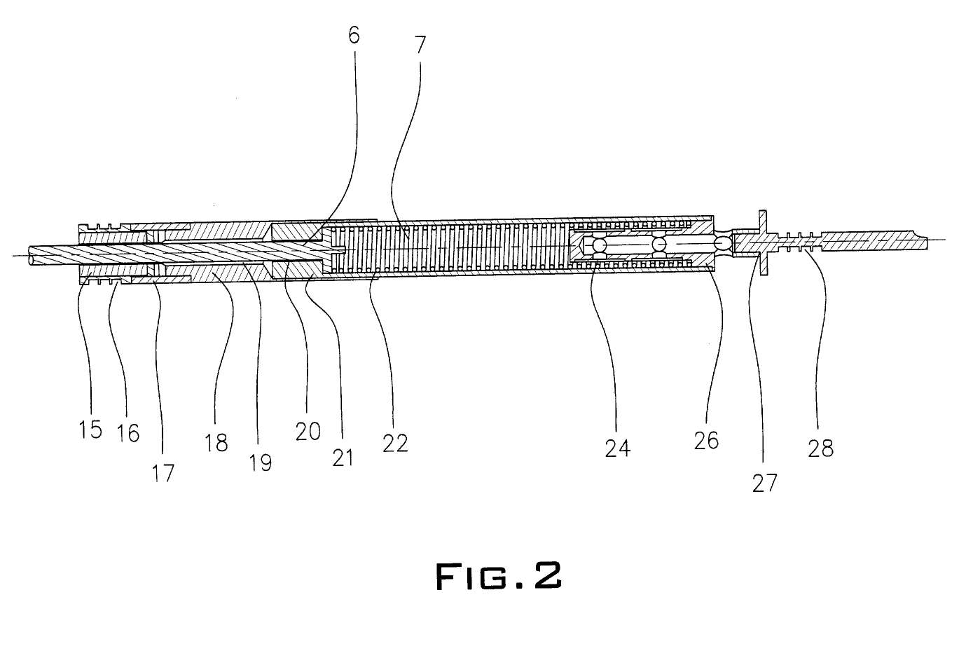

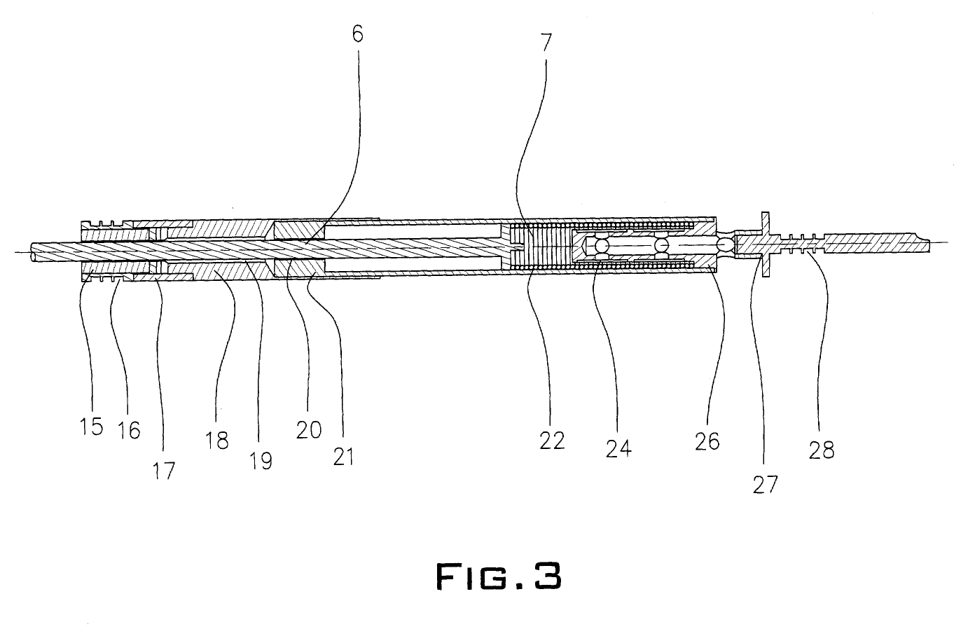

A compression spring 22 is inserted in the female contact 7 and acts on a sliding piston 6, which in the cylindrical inner space formed by the sealing sleeve 15, the front contact receptacle 18, and the front contact support 21, is displaceably arranged between the position shown in FIG. 2 and that shown in FIG. 3.

The internal diameter of the sealing sleeve 15 corresponds to the diameter of the sliding piston 6 and the contact pin diameter of the plug part of the connector coinciding therewith. The internal diameter of the front contact receptacle 18 is larger than the diameter of the sliding piston 6 so that an annular space 19 is formed between the shaft of the sliding piston 6 and the front contact receptacle 18.

If for producing a connection a contact pin of the plug part is engaged on the opening in the front plate 1, a front face engaging with the outwardly directed end face of the sliding piston 6 wherein the contact pin is then pressed into the female contact 7, the sliding piston 6 enters the space of the female contact 7 followed by the contact pin. The sliding piston 6 displaces oil from the oil-filled space of the female contact 7, which flows past the annular space 19 at the sliding piston shaft counter to the piston movement direction. During this process, the oil in the socket contact area is replaced and contaminants are flushed through the valve 17 into the space 29.

When the front end of the contact pin has passed the sealing sleeve 15, the oil displaced by the sliding piston 6 from the space fo the female contact 7 flows along the contact pin and insulation zone so that the water film (or a contaminant), resting on the contact pin and insulation zone, is flushed away by the oil. The oil, carrying with it the water stripped off from the contact pin in the inner space 29 surrounding the female contact 7, passes through the valve 17 and out of said contact 7. This reliably ensures that water does not enter the vicinity of the socket contact lamella 20 or in the insulation zone, and does not lead to an electric short-circuit with the surrounding sea water.

The diaphragm 5 is designed in such a way that the inner space 29 can receive an additional fluid quantity corresponding to the volume of the contact pin penetrating the female contact.

On releasing the connection, i.e. on extracting the contact pin, the compression spring 22 forces the sliding piston 6 back into the position shown in FIG. 2. During this process, the valve 24 opens so that oil from the inner space 29 flows through the filter 12 into the space of the female contact 7.

In addition to the fluid, the inner space 29 can receive a hydrophilic material which holds back water that has entered the inner space 29, even after numerous plugging processes prevent the reentry of water into the space of the female contact 7. The sliding piston 6 can be provided with a circumferential ring groove which transports the oil out of the annular space 19.

Having thus described the invention, what is claimed and desired to be secured by Letters Patent is:

8. A pressure compensated plug connector comprising:
a) a plug part provided with at least one contact pin;
b) a socket part having a casing receiving a number of female contacts corresponding to the number of contact pins of the plug part;
c) a front plate having a number of openings corresponding to and aligned with the number of female contacts in which the casing has at least one pressure compensating bore bringing about a pressure compensation between the inner space of the casing and the environment;
d) a membrane bounding an outer space communicating with the pressure compensating bore from an inner space filled with a nonconducting fluid and surrounding the female contact, the female contacts having an opening-adjacent sealing sleeve;
e) a front contact support;
f) a sliding piston displaceable therein and whose diameter corresponds to that of the contact pin, and a spring loading the sliding piston in the direction of the opening, characterized in that the female contacts are provided with an outlet valve located in the area between the sealing sleeve and the front contact support, connecting in the unplugged state the space occupied by the sliding piston to the inner space, and opening to the inner space on introducing the contact pin into the female contact; and
g) an inlet valve located in a rear area of the female contact spaced from the opening connecting the inner space with the space of the female contact, and opening to the inner space on extracting the contact pin from the female contact, allowing an afterflow of fluid into the space of the female contact.

9. The pressure compensated plug connector of claim 8, wherein the female contacts are provided with a front contact reception sleeve between the outlet valve and the front contact support, leaving a flushing annular space between the same and the sliding piston.

10. The pressure compensated plug connector of claim 8, wherein a separating system is located in the path between the inner space and the inlet valve.

11. The pressure compensated plug connector of claim 10, wherein the separating system is a filter.

12. The Pressure compensated plug connector of claim 10, wherein a hydrophilic material is introduced into the inner space for purposes of holding back water as its introduced into the inner space.

13. The pressure compensated plug connector of claim 8, wherein a diaphragm located between the outer space and the inner space forms a further gap separated from the outer space.

14. The pressure compensated plug connector of claim 8, wherein the sliding piston is provided with at least one circumferential ring groove.
